(19) United States
(12) Patent Application Publication
(10) Pub. No.: US 2007/0027017 A1
(43) Pub. Date: Feb. 1, 2007

(54) Optical glass, optical element and process for the production thereof

(75) Inventor: Youichi Hachitani, Tokyo (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 11/488,892

(22) Filed: Jul. 19, 2006

(30) Foreign Application Priority Data
Jul. 28, 2005 (JP) 2005-218630
Jun. 7, 2006 (JP) 2006-158151

(51) Int. Cl. C03C 3/19; C03C 3/17; C03C 3/062; C03C 3/064; C03B 11/00; C03B 23/00

(52) U.S. Cl. 501/47; 501/48; 501/73; 501/77; 65/66; 65/102

(57) ABSTRACT

Provided are an optical glass having high-refractivity, low-dispersion and anomalous partial dispersion properties, having excellent processability, being excellent as an anomalous partial dispersion glass for suppressing chromatic aberration, containing P⁵⁺, Al³⁺ and alkaline earth metal ions selected from the group consisting of Mg²⁺, Ca²⁺, Sr²⁺ and Ba²⁺ as essential cationic components and F⁻ and O²⁻ as essential anionic components, wherein the ratio of content of Ba²⁺ to the total content R²⁺ of Mg²⁺, Ca²⁺, Sr²⁺ and Ba²⁺, Ba²⁺/R²⁺, is 0.01 or more but less than 0.5 on the basis of cationic %, and having an Abbe's number (νd) of 68 or more, optical glass having an Abbe's number (νd) of 68 or more, a partial dispersion ratio of 0.535 or more and a frictional abrasion of 500 or less and an optical glass which is to be polished in a polishing step for producing an optical element and which is a fluorophosphate glass having a frictional abrasion of 500 or less.

### TECHNICAL FIELD

The present invention relates to an optical glass, an optical element and a process for the production thereof. More specifically, it relates to an optical glass having high-refractivity, low-dispersion and anomalous partial dispersion properties suitable for use as a glass for a lens for a camera or projector and having excellent processability, an optical element formed of the above glass and a process for the production of the optical element.

### TECHNICAL BACKGROUND

In optical systems such as a camera, etc., there is generally employed a design for “achromatism”, in which glasses having different Abbe's numbers are combined for removing chromatic aberration of a lens. It produces a great effect on the above removal to combine glasses that are greatly different in Abbe's number. In particular, secondary achromatization requires an anomalous-partial-dispersion glass that has a partial dispersion ratio different from that of a normal optical glass. As an optical glass having a large Abbe's number and having the property of anomalous partial dispersion, fluorophosphate glasses having an Abbe's number of 80 or more have been put to practical use. Since, however, these fluorophosphate glasses have a refractive index of 1.5 or less, they are not suitable for a lens having large refractive power.

On the other hand, as an anomalous-partial-dispersion glass having a refractive index of over 1.5, for example, there is disclosed a fluorophosphate glass having a refractive index of 1.54 to 1.60, an Abbe's number of 68 to 75 and a partial dispersion ratio of at least 0.537 (for example, see JP-A-4-43854). However, this fluorophosphate glass is poor in mechanical properties and thermal properties and further has a problem that its frictional abrasion is large and that its processability is poor. It hence inevitably increases a processing cost, and it has been difficult to provide less expensive high-performance lenses.

As a light-weight anomalous-partial-dispersion glass, further, there is proposed an optical glass having a refractive index of 1.54 to 1.60, an Abbe's number of 70 to 80 and a specific gravity of less than 4.1 (for example, see JP-A-2003-160356). This optical glass is light in weight and excellent in optical properties, while it cannot be said that the glass is fully satisfactory in any one of mechanical properties, thermal properties and frictional abrasion.

### DISCLOSURE OF THE INVENTION

[Problems to be Solved by the Invention]

Under the circumstances, it is an object of the present invention to provide a high-refractivity low-dispersion optical glass having the property of anomalous partial dispersion and having excellent processability, an optical element formed of the above optical glass such as a high-performance lens and a process for the production of such an optical element.

[Means to Solve the Problems]

For achieving the above object, the present inventor has made diligent studies and as a result it has been found that an optical glass having a specific glass composition can achieve the above object. On the basis of this finding, the present invention has been accordingly completed.

That is, the present invention provides

(1) an optical glass comprising P⁵⁺, Al³⁺ and alkaline earth metal ions selected from the group consisting of Mg²⁺, Ca²⁺, Sr²⁺ and Ba²⁺ as an essential cationic component and comprising F⁻ and O²⁻ as essential anionic components,

wherein the ratio of content of Ba²⁺ to the total content R²⁺ of Mg²⁺, Ca²⁺, Sr²⁺ and Ba²⁺, Ba²⁺/R²⁺, is 0.01 or more but less than 0.5 on the basis of cationic %,

the optical glass having an Abbe's number (νd) of 68 or more (to be referred to as “optical glass I” hereinafter),

(2) an optical glass as recited in the above (1), which contains, by cationic %, 20 to 50% of P⁵⁺ and 0.1 to 20% of Al³⁺,

(3) an optical glass as recited in the above (1), wherein the total content of Mg²⁺, Ca²⁺, Sr²⁺ and Ba²⁺ is 35 to 60 cationic %,

(4) an optical glass as recited in the above (1), which contains, by cationic %, 0.1 to 20% of Mg²⁺, 0 to 20% of Ca²⁺, 0 to 20% of Sr²⁺ and 0.1 to 20% of Ba²⁺

(5) an optical glass as recited in the above (1), which contains 0.1 to 10 cationic % of Y³⁺,

(6) an optical glass as recited in the above (1), which contains 0.1 to 20 cationic % of B³⁺,

(7) an optical glass as recited in the above (1), which contains 30 to 60 anionic % of F⁻.

(8) an optical glass as recited in the above (1), which has a refractive index (nd) of 1.54 or more,

(9) an optical glass as recited in the above (1), which has a frictional abrasion of 500 or less,

(10) an optical glass as recited in the above (1), which has a partial dispersion ratio of 0.535 or more,

(11) an optical glass having an Abbe's number (νd) of 68 or more, a partial dispersion ratio of 0.535 or more and a frictional abrasion of 500 or less (to be referred to as “optical glass II” hereinafter),

(12) an optical glass as recited in the above (11), which contains 0.1 to 20 cationic % of B³⁺,

(13) an optical glass as recited in the above (11), which has a refractive index (nd) of 1.54 or more,

(14) an optical glass which is to be polished in a polishing step for producing an optical element and which is a fluorophosphate glass having a frictional abrasion of 500 or less (to be referred to as “optical glass III” hereinafter),

(15) an optical glass as recited in the above (14), which contains 0.1 to 20 cationic % of B³⁺,

(16) an optical glass as recited in any one of the above (1), (11) or (14), which has a specific gravity of less than 4.0,

(17) an optical element formed of the optical glass recited in any one of the above (1), (11) or (14),

(18) a process for the production of an optical element, which comprises the steps of preparing a press-molding glass gob formed of the optical glass recited in any one of the above (1), (11) or (14), heating said glass gob and press-molding said glass gob, and

(19) a process for the production of an optical element, which comprises melting a glass, causing the molten glass to flow out to form a glass shaped material formed of the optical glass recited in any one of the above (1), (11) or (14), and processing said glass shaped material.

### EFFECT OF THE INVENTION

According to the present invention, there can be provided an optical glass having high-refractivity, low-dispersion and anomalous partial dispersion properties suitable for use as a glass for a lens for a camera or projector and having excellent processability, an optical element formed of the above glass such as a high-performance lens and a process for the production of the optical element.

The optical glass of the present invention is suitably used particularly as an anomalous partial dispersion glass for suppressing chromatic aberration. Further, having a low glass transition temperature, the optical glass of the present invention can be press-molded at a low temperature and is suitable for mold-press-molding (precision press-molding) with a precision-processed mold.

### PREFERRED EMBODIMENTS OF THE INVENTION

The optical glass of the present invention includes three embodiments, an optical glass I, an optical glass II and an optical glass III.

The optical glass I is an optical glass which comprises P⁵⁺, Al³⁺ and alkaline earth metal ions selected from the group consisting of Mg²⁺, Ca²⁺, Sr²⁺ and Ba²⁺ as essential cationic components and comprises F⁻ and O²⁻ as essential anionic components,

wherein the ratio of content of Ba²⁺ to the total content R²⁺ of Mg²⁺, Ca²⁺, Sr²⁺ and Ba²⁺, Ba²⁺/R²⁺, is 0.01 or more but less than 0.5 on the basis of cationic %,

the optical glass having an Abbe's number (νd) of 68 or more.

The above optical glass I has high-refractivity, low-dispersion and anomalous partial dispersion properties, so that it is an optical glass effective for correcting chromatic aberration and downsizing a lens unit. There is no special restriction to be imposed on the upper limits of the refractive index (nd) and Abbe's number (νd) of the optical glass I. For realizing excellent devitrification resistance and processability, preferably, it is determined that the refractive index is 1.54 or more, preferably 1.54 to 1.60 and that the Abbe's number (νd) is 68 to 78. Further, the optical glass 1 can realize anomalous partial dispersion represented by a partial dispersion ratio of 0.535 or more.

In a preferred embodiment, the optical glass I has a specific gravity of less than 4.0 and a lens can be decreased in weight, so that the load on a driving motor in an autofocus mechanism is small. In the optical glass I, an optical glass having a specific gravity of 3.9 or less is preferred, and an optical glass having a specific gravity of 3.8 or less is more preferred.

The optical glass I generally has a frictional abrasion of 500 or less and hence has excellent processability. Any conventional fluorophosphate glass has a large frictional abrasion and hence has a disadvantage that a processed surface is decreased in accuracy or that a polishing mark remains. According to the optical glass I, however, the frictional abrasion is small for a fluorophosphate glass, so that the abrasion during processing is small. The optical glass I is not too soft, so that a processed surface of the optical glass I can have high accuracy. Further, no polishing mark easily remains on the polished surface thereof. The frictional abrasion of the optical glass I is preferably 450 or less, more preferably 400 or less.

In a preferred embodiment, the optical glass I has an average linear expansion coefficient, measured at 100° C. to 300° C., of less than 160×10⁻⁷/° C., and it is hence excellent in thermal shock resistance. Thanks to this property, a cracking caused by temperature differences of a cutting oil during its polishing and a washing medium does not easily occur. When the glass is surface-coated by vapor deposition, etc., the time period for cooling the glass to room temperature can be decreased. The above expansion coefficient is preferably less than 150×10⁻⁷/° C., more preferably less than 140×10⁻⁷/° C.

The composition of the optical glass I will be explained in detail below. Cation contents and total cation contents shown by % below stand for cation contents and total cation contents by cationic %.

P⁵⁺ is a basic component for a fluorophosphate glass and is an essential component for obtaining devitrification resistance and a high refractive index. When the content of P⁵⁺ is less than 20%, the devitrification resistance decreases, and the refractive index is liable to decrease. When it exceeds 50%, the devitrification resistance is degraded, and the Abbe's number may be too small. The content of P⁵⁺ is hence preferably 20 to 50%, more preferably 25 to 45%, still more preferably 30 to 40%.

Al³⁺ is an essential component for improving the devitrification resistance of the fluorophosphate glass and suppressing the thermal expansion of the glass. When the content of Al³⁺ is less than 0.1%, the devitrification resistance is poor, and the liquidus temperature is too high, so that it is difficult to form a quality glass by melting. When it exceeds 20%, the devitrification resistance tends to be degraded. The content of Al³⁺ is hence preferably 0.1 to 20%, more preferably 1 to 13%, still more preferably 5 to 10%.

In addition to P⁵⁺ and Al³⁺, the optical glass I contains, as an essential cationic component, alkaline earth metal ions selected from the alkaline earth metal ion groups consisting of Mg²⁺, Ca²⁺, Sr²⁺ and Ba²⁺. The alkaline earth metal ions are introduced for improving the devitrification resistance of the fluorophosphate glass and also for adjusting optical properties thereof. Ba²⁺ works to increase the refractive index. However, when introduced to excess, Ba²⁺ increases the specific gravity and thermal expansion of the fluorophosphate glass and increases the frictional abrasion to degrade the processability, so that it is therefore desirable to impose a limitation on the ratio of the Ba²⁺ content to the total content of the alkaline earth metal ions. In the optical glass I, the ratio of the Ba²⁺ content to the total content R²⁺ of Mg²⁺, Ca²⁺, Sr²⁺ and Ba²⁺, Ba²⁺/R²⁺, is limited to 0.01 or more but less than 0.5. When the ratio of Ba²⁺/R²⁺ is 0.5 or more, the frictional abrasion is increased, and the processability is hence degraded. The ratio of Ba²⁺/R²⁺ is preferably 0.01 or more but not more than 0.4.

For accomplishing the objects of the present invention while improving the glass in devitrification resistance, the above total content R²⁺ is preferably adjusted to 35 to 60%, more preferably to 40 to 55%.

Functions and preferred contents of the above alkaline earth metal ions will be explained below.

Mg²⁺ is an important cationic component that improves the devitrification resistance of the fluorophosphate glass and further decreases the specific gravity and decreases the frictional abrasion to improve the glass in processability. When the content of Mg²⁺ is less than 0.1%, it is difficult to produce these effects thereof. When it exceeds 20%, the refractive index may decrease and at the same time the devitrification resistance may decrease. The content of Mg²⁺ is hence preferably 0.1 to 20%, more preferably 5 to 18%, still more preferably 8 to 15%.

Ca²⁺ is a cationic component that improves the devitrification resistance of the fluorophosphate glass and further decreases the frictional abrasion thereof to improve the glass in processability. When the content of Ca²⁺ exceeds 20%, the refractive index may decrease and at the same time the devitrification resistance may decrease. The content of Ca²⁺ is hence preferably 0 to 20%, more preferably 1 to 18%, still more preferably 5 to 15%.

Sr²⁺ is a cationic component that improves the devitrification resistance of the fluorophosphate glass and improves the refractive index thereof. When the content of Sr²⁺ exceeds 20%, the refractive index may decrease and at the same time the devitrification resistance may decrease. The content of Sr²⁺ is hence preferably 0 to 20%, more preferably 1 to 18%, still more preferably 5 to 15%.

Although Ba²⁺ is a component that increases the specific gravity and the thermal expansion and further increases the frictional abrasion to degrade the processability, it is preferred to add a small amount of Ba²⁺ for the purpose of improve the fluorophosphate glass in devitrification resistance and refractivity. When the content of Ba²⁺ is less than 0.1%, the glass is liable to devitrify, and when it exceeds 20%, the frictional abrasion tends to increase to degrade the processability. The content of Ba²⁺ is hence preferably 0.1 to 20%, more preferably 1 to 20%. When priority is given to the processability of the glass, the content of Ba²⁺ is preferably 1 to 15%, more preferably 5 to 10%. When priority is given to an improvement in the devitrification resistance of the glass and an increase in the refractive index thereof, the content of Ba²⁺ is more preferably 5 to 20%.

Y³⁺ is a component that not only improves the refractivity of the optical glass I but also improves the devitrification resistance and processability thereof without impairing the anomalous partial dispersion property. When the content of Y³⁺ is less than 0.1%, the effect thereof is insufficient, and when it exceeds 20%, the glass tends to devitrify. When Y³⁺ is introduced, the content thereof is preferably 0.1 to 10%, more preferably 1 to 8%, still more preferably 1 to 5%.

While La³⁺ is not an essential component, it is a cationic component that improves the refractivity of the optical glass I without impairing the anomalous partial dispersion property, and a small amount of La³⁺ may be added as an auxiliary to Y³⁺. When the content of La³⁺ exceeds 5%, however, the glass is liable to devitrify. The content of La³⁺ is hence preferably 0 to 3%, more preferably 0 to 1%.

While B³⁺ is not an essential component, it is a cationic component that improves the refractivity of the optical glass I and that also decreases the specific gravity and improves the optical glass I in devitrification resistance and processability without impairing the anomalous partial dispersion property. However, when B³⁺ is added to the optical glass I containing F⁻, an intense volatilization occurs when the glass is melted, which is not much desirable from the viewpoint of industrial operations. Further, the volatilization causes striae. When the content of B³⁺ exceeds 20%, the glass is liable to devitrify. The content of B³⁺ is hence preferably 0 to 20%, more preferably 0 to 15%. In addition, when a dust collector can be provided for a glass melting apparatus and if the influence that the volatilization caused by the introduction of B³⁺ has on the environments can be completely suppressed, it is preferred to introduce B³⁺ that has the above-explained effects. In this case, the content of B³⁺ is preferably 0.1 to 20%, more preferably 5 to 15%.

Although being not any essential component, Si⁴⁺ is a cationic component that improves the refractivity of the optical glass I and that also decreases the specific gravity of the optical glass I and improves the optical glass I in devitrification resistance and processability without impairing the anomalous partial dispersion property. However, when Si⁴⁺ is added to the optical glass I, an intense volatilization occurs when the glass is melted, which is not much desirable from the viewpoint of industrial operations. Further, when Si⁴⁺ is introduced to excess, the glass is liable to devitrify. The content of Si⁴⁺ is hence preferably 0 to 10%, more preferably 0 to 5%. As is explained with regard to B³⁺, however, when a dust collector can be provided for a glass melting apparatus and if the influence that the volatilization caused by the introduction of Si⁴⁺ has on the environments can be completely suppressed, it is preferred to introduce Si⁴⁺ that has the above-explained effects. In this case, the content of Si⁴⁺ is preferably 0.1 to 10%, more preferably 0.1 to 5%.

P⁵⁺, B³⁺ and Si⁴⁺ are components that contribute to an improvement of the devitrification resistance of the glass, and the total content of these is preferably 35 to 55%, more preferably 35 to 50%.

For adjusting the refractive index and the Abbe's number (νd) of the optical glass I, improving the devitrification resistance thereof and adjusting the thermal properties thereof, Sb³⁺, Zn²⁺, Li⁺, Na⁺ and K⁺ may be added such that the total content of these is less than 5%. The total content of these is preferably 2% or less.

Other cationic components may be introduced to such an extent that the objects of the present invention are not impaired. However, the total content of P⁵⁺, Al³⁺, Mg²⁺, Ca²⁺, Sr²⁺, Ba²⁺, Y³⁺, La³⁺, B³⁺ and Si⁴⁺ in the optical glass I is preferably over 95%, more preferably 98% or more, still more preferably 99% or more, yet more preferably 100%.

F⁻ is an essential anionic component that increases the Abbe's number (νd) and improves the anomalous partial dispersion property. However, it decreases the strength of the glass network structure, so that it can be a component that increases the thermal expansion and the frictional abrasion of the glass. When the content of F⁻ is less than 30 anionic %, the Abbe's number is small, and no sufficient anomalous partial dispersion property can be obtained. When it exceeds 60 anionic %, the Abbe's number is too large, and the thermal expansion coefficient and the frictional abrasion may increase. Further, when the glass is used in precision press-molding, intense volatilization takes place, so that the content of F⁻ is preferably limited to 30 to 60 anionic %. The content of F⁻ is more preferably in the range of 35 to 55 anionic %, still more preferably in the range of 35 to 50 anionic %.

The optical glass I is a fluorophosphate glass and contains O²⁻ apart from F⁻. The content of O²⁻ is preferably 40 to 70 anionic %, more preferably 44 to 65%, still more preferably 50 to 65 anionic %. It is further preferred to adjust the total content of F⁻ and O²⁻ to 100 anionic %.

The optical glass II of the present invention is an optical glass having an Abbe's number (νd) of 68 or more, a partial dispersion ratio of 0.535 or more and a frictional abrasion of 500 or less. Preferred glass compositions and various properties including the refractive index (nd) explained with regard to the optical glass I can be applied to the optical glass II.

The optical glass III of the present invention is an optical glass that is to be polished in a polishing step for producing an optical element and is a fluorophosphate glass having a frictional abrasion of 500 or less. The fluorophosphate glass is useful for obtaining a low-dispersion property represented by an Abbe's number (νd) of 68 or more. A low-dispersion glass is particularly effective as a most-object-side lens of an image-sensing optical system or a light-outgoing-side lens of a projector optical system, and these lenses have large diameters in many cases. When such large-diameter lenses are produced, it is required to produce lenses free of polishing marks over a large area each. The optical glass III can be a fluorophosphate glass and the frictional abrasion thereof is as small as 500 or less, so that optical elements having high surface accuracy can be highly productively produced from the optical glass III by polishing without leaving any polishing mark. Preferred ranges of the frictional abrasion described with regard to the optical glasses I and II can be also applied the optical glass III.

The optical glass III preferably has the same thermal expansion properties as those of the optical glasses I and II. The fluorophosphate glass is particularly useful as a material for large-diameter lenses as described above. When such large-diameter optical elements are produced from a glass by polishing, the glass is liable to break if it has a large thermal expansion coefficient. In the above preferred embodiment, large-diameter optical elements having excellent surfaces can be highly productively produced by polishing without breaking them. Preferred glass compositions and various properties (such as a refractive index (nd), Abbe's number (νd), partial dispersion property, specific gravity, etc.) explained with regard to the optical glasses I and II can be applied to the optical glass III.

According to the present invention, there is also provided an optical element formed of the optical glass I, II or III, and there are also provided a process for the production of an optical element, which comprises the steps of preparing a press-molding glass gob formed of the optical glass I, II or III, heating the above glass gob and press-molding it, and a process for the production of an optical element, which comprises the step of melting a glass, causing the molten glass to flow out to shape the molten glass into a glass shaped material formed of the above optical glass I, II or III and processing the glass shaped material.

For producing a glass shaped material or press-molding glass gob formed of the optical glass of the present invention and further for obtaining an optical element, for example, the following method can be employed.

First, raw materials such as phosphate, fluoride, carbonate, nitrate, oxide, etc., are provided as required, the raw materials are weighed such that a desired glass composition can be obtained, the thus-prepared raw materials are mixed, and the mixture is melted in a refractory crucible at a temperature of approximately 900 to 1,200° C. Hydroxide, hydrate, etc., promote the volatilization of fluorine, so that it is preferred not to use them. When the mixture is melted, desirably, a refractory cover is used. A glass in a molten state is stirred and refined, and then the shaping of a glass is carried out. The shaping method can be selected from conventional methods such as a casting method, a bar material shaping method, a press-molding method and the like. A shaped glass is transferred into an annealing furnace which is previously heated to a temperature around the transition temperature of the glass, and the shaped glass is gradually cooled to room temperature. The thus-obtained glass shaped material is cut, ground or polished as required. As required, the glass shaped material can be cut and a cut piece can be heated and pressed or pressed under heat. Alternatively, a precision gob can be prepared, heated and precision press-molded in an aspherical form. In this manner, a predetermined optical element can be produced.

In shaping a glass in a molten state into a glass shaped material, a volatilization from the high-temperature glass surface causes striae, so that it is desirable to suppress the volatilization from the glass surface when a molten glass is caused to flow out and shaped. For this purpose, it is preferred to employ a method in which a molten glass is caused to flow out and shaped in a dry atmosphere or a method in which a molten glass is caused to flow out and shaped in an atmosphere of an inert gas (which is more desirably a dry inert gas) such as a nitrogen gas, or the like. In the case of cast-shaping, it is preferred to employ a constitution in which a glass in a casting mold is not exposed to ambient atmosphere. It is hence preferred to employ a method in which a casting mold having a through hole is provided, a molten glass is introduced through one opening portion of the through hole to fill molten glass inside the through hole and a glass shaped material formed in the through hole is withdrawn from the other opening portion of the through hole. In particular, when the through hole is provided as straight as a straight line, the glass moves smoothly, and a glass portion near the surface of a cast glass and a glass portion inside the cast glass are not mixed in the through hole, so that when the surface of the molten glass is altered by the volatilization, the altered portion can be limited to the surface of the glass shaped material. Therefore, an optically uniform glass shaped material can be obtained by removing the glass surface by grinding or polishing. From the above viewpoint, it is preferred to employ a constitution in which the casting mold is arranged such that the through hole is vertically positioned, a molten glass is cast through an upper opening portion and a glass shaped is withdrawn from a lower opening portion. In the above casting, it is desirable to employ a constitution in which the space including the pipe outlet from which a molten glass is caused to flow out and the through hole opening portion through which the molten glass is cast is isolated and the isolated space is filled with the above atmosphere, for producing an optically uniform glass shaped material. For preventing the glass shaped material withdrawn from the casting mold from breaking due to its rapid cooling, it is preferred to carry out the procedure of bringing the temperature inside the glass shaped material and the temperature of surface of the glass shaped material close to each other. Specifically, the glass shaped material withdrawn from the casting mold is placed in an atmosphere whose temperature is maintained at a temperature around the glass transition temperature of the glass, and the above procedure is carried out. While the form of the glass shaped material is determined depending upon the form of the through hole, the above shaping method is suitable for producing a glass shaped material having a rod-shaped form such as a columnar form, a prismatic shape or the like.

### EXAMPLES

The present invention will be explained further in detail with reference to Examples hereinafter, while the present invention shall not be limited by these Examples.

### Examples 1-10 and Comparative Examples 1 and 2

Raw materials such as phosphates, fluorides, carbonates, nitrates, oxides, etc., were prepared as required and the raw materials were weighed such that glass compositions shown in Tables 1 and 2 were obtained. Hydroxides, etc., were not used since they would promote the volatilization of fluorine. As a raw material for B³⁺, anhydrous materials such as boron phosphate (BPO₄) and boric acid anhydride (B₂O₃) were used in place of boric acid. In each Example, formulated raw materials were mixed, and the mixture was melted in a platinum crucible. The glass in each Example underwent melting at 900 to 1,200° C.

In each Example, the glass was stirred and refined, and caused to flow out on an iron plate to form a block. And, the glass block was transferred into a furnace that had been heated to a temperature around the glass transition temperature, and it was annealed to room temperature.

Samples for various measurements were taken from each of the thus-obtained glass blocks, and they were measured for physical properties as follows.

Refractive index (nd) and Abbe's number (νd) A sample was measured for a refractive index (nd) and Abbe's number (νd) according to Japan Optical Glass Industrial Society Standard JOGIS-01.

Partial dispersion ratio (Pg,F)
Determined on the basis of Pg,F=(ng−nc)/(nF−nc) using refractive indices of g-ray, F-ray and c-ray.

Average linear expansion coefficient (α) at 100° C. to 300° C.
A sample was measured according to Japan Optical Glass Industrial Society Standard JOGIS-08.

Specific gravity (Sg)
A sample was measured according to Japan Optical Glass Industrial Society Standard JOGIS-05.

Frictional abrasion (FA)
A sample was measured according to Japan Optical Glass Industrial Society Standard JOGIS-10.

Tables 1 and 2 show the measurement results.

TABLE 1

| | | | Ex. 1 | Ex. 2 | Ex. 3 | Ex. 4 | Ex. 5 | Ex. 6 |
|---|---|---|---|---|---|---|---|---|
| Cationic | P⁵⁺ | cat % | 32.3 | 39.8 | 32.9 | 37.5 | 34.5 | 32.8 |
| component | B³⁺ | cat % | 12.3 | 0.0 | 11.9 | 0.0 | 10.3 | 12.0 |
| | Si⁴⁺ | cat % | 0.0 | 0.0 | 0.0 | 7.3 | 0.0 | 0.0 |
| | Al³⁺ | cat % | 8.5 | 7.6 | 8.5 | 8.5 | 8.5 | 8.5 |
| | Mg²⁺ | cat % | 10.3 | 9.2 | 13.0 | 12.6 | 3.8 | 10.2 |
| | Ca²⁺ | cat % | 12.0 | 10.7 | 14.9 | 0.0 | 12.0 | 10.7 |
| | Sr²⁺ | cat % | 14.3 | 12.7 | 0.0 | 16.3 | 14.3 | 14.3 |
| | Ba²⁺ | cat % | 6.6 | 16.8 | 15.2 | 14.2 | 13.0 | 6.6 |
| | La³⁺ | cat % | 0.0 | 0.0 | 0.0 | 0.0 | 0.0 | 1.3 |
| | Gd³⁺ | cat % | 0.0 | 0.0 | 0.0 | 0.0 | 0.0 | 0.0 |
| | Y³⁺ | cat % | 3.7 | 3.2 | 3.6 | 3.6 | 3.6 | 3.6 |
| | Na⁺ | cat % | 0.0 | 0.0 | 0.0 | 0.0 | 0.0 | 0.0 |
| | Ba²⁺/R²⁺ | — | 0.15 | 0.34 | 0.35 | 0.33 | 0.30 | 0.16 |
| An. cpnt | O²⁻ | an % | 56 | 60 | 55 | 58 | 57 | 55 |
| | F⁻ | an % | 44 | 40 | 45 | 42 | 43 | 45 |

| | | | | | | | |
|---|---|---|---|---|---|---|---|
| Refractive index | — | 1.56045 | 1.56172 | 1.57032 | 1.56595 | 1.56868 | 1.56318 |
| [nd] | | | | | | | |
| Abbe's number | — | 71.58 | 71.01 | 70.32 | 71.01 | 70.47 | 71.47 |
| (νd) | | | | | | | |
| Partial dispersion | — | 0.5428 | 0.5424 | 0.5425 | 0.542 | 0.544 | 0.547 |
| ratio [Pg, F] | | | | | | | |
| Average linear | ×10⁻⁷/° C. | 139 | 147 | 155 | 139 | 138 | 134 |
| expansion coefficient | | | | | | | |
| [α] | | | | | | | |
| Specific gravity | — | 3.63 | 3.84 | 3.86 | 3.83 | 3.83 | 3.69 |
| [Sg] | | | | | | | |
| Frictional abrasion | — | 330 | 470 | 380 | 450 | 440 | 400 |
| [FA] | | | | | | | |

Notes:
Ex. = Example,
An. cpnt = Anionic component
(cat %: cationic %, an %: anionic %)

TABLE 2

| | | | Ex. 7 | Ex. 8 | Ex. 9 | Ex. 10 | CEx. 1 | CEx. 2 |
|---|---|---|---|---|---|---|---|---|
| Cationic | P⁵⁺ | cat % | 25.6 | 26.1 | 41.0 | 37.7 | 37.9 | 45.0 |
| component | B³⁺ | cat % | 13.5 | 13.0 | 0.0 | 9.9 | 0.0 | 0.0 |
| | Si⁴⁺ | cat % | 0.0 | 0.0 | 0.0 | 0.0 | 0.0 | 0.0 |
| | Al³⁺ | cat % | 9.3 | 2.7 | 10.5 | 12.5 | 12.3 | 18.8 |
| | Mg²⁺ | cat % | 11.1 | 7.6 | 10.5 | 6.0 | 0.0 | 0.0 |
| | Ca²⁺ | cat % | 13.3 | 14.9 | 5.4 | 10.3 | 0.0 | 0.9 |
| | Sr²⁺ | cat % | 15.7 | 15.8 | 20.9 | 12.3 | 16.0 | 1.0 |
| | Ba²⁺ | cat % | 10.9 | 15.9 | 8.0 | 8.5 | 25.8 | 30.6 |
| | La³⁺ | cat % | 0.0 | 0.0 | 0.1 | 0.0 | 0.0 | 0.3 |
| | Gd³⁺ | cat % | 0.0 | 0.0 | 0.0 | 0.0 | 6.6 | 0.0 |
| | Y³⁺ | cat % | 0.6 | 4.0 | 3.6 | 2.8 | 0.2 | 3.4 |
| | Na⁺ | cat % | 0.0 | 0.0 | 0.0 | 0.0 | 1.2 | 0.0 |
| | Ba²⁺/R²⁺ | — | 0.21 | 0.29 | 0.18 | 0.23 | 0.62 | 0.94 |
| An. cpnt | O²⁻ | an % | 52 | 53 | 56 | 60 | 59 | 61 |
| | F⁻ | an % | 48 | 47 | 44 | 40 | 41 | 39 |

| | | | | | | | |
|---|---|---|---|---|---|---|---|
| Refractive index | — | 1.54006 | 1.54188 | 1.56014 | 1.53727 | 1.56907 | 1.56802 |
| [nd] | | | | | | | |
| Abbe's number | — | 74.29 | 74.75 | 71.54 | 74.83 | 71.3 | 71.44 |
| (νd) | | | | | | | |
| Partial dispersion | — | 0.5433 | 0.547 | 0.5415 | 0.5462 | 0.545 | 0.5333 |
| ratio [Pg, F] | | | | | | | |
| Average linear | ×10⁻⁷/° C. | 155 | 145 | 152 | 138 | 156 | 139 |
| expansion | | | | | | | |
| coefficient [α] | | | | | | | |
| Specific gravity | — | 3.76 | 3.83 | 3.74 | 3.66 | 4.48 | 4.05 |
| [Sg] | | | | | | | |
| Frictional abrasion | — | 350 | 400 | 450 | 390 | 620 | 620 |
| [FA] | | | | | | | |

Notes:
Ex. = Example,
CEx. = Comparative Example,
An. cpnt = Anionic component
(cat %: cationic %, an %: anionic %)

### Example 11

Glass shaped materials formed of the glasses described in Examples 1 to 10 were obtained in the following manner. In each case of the glass shaped materials, glass raw materials were heated, melted, refined and homogenized in a melting vessel to prepare a molten glass, and the molten glass was caused to flow out and cast into a mold to form a glass shaped material having the form of a rod, a glass shaped material having the form of a plate, or the like.

The glass shaped materials were gradually cooled and then cut or split to divide them to glass pieces called “cut pieces”, and the cut pieces were machine-processed to form press-molding glass gobs having a predetermined weight each.

A powdery mold release agent such as boron nitride or the like was uniformly applied to the surface of each of the glass gobs, and each glass gob was heated to be softened and press-molded with a press mold in atmosphere. Each of the press-molded products had a form obtained by adding a margin to be removed by machine-processing to the form of an optical element as an end product. The press-molded products were annealed to reduce their strains, and then they were ground and polished to give optical elements formed of the optical glasses of Examples 1 to 10. Defects such as polishing marks, etc., were not observed on the surface of each of the above-produced optical elements, and high quality optical elements could be produced. Further, the above machine-processing was carried out without breaking any glass.

In addition, the formation of the above glass shaped materials, the preparation of the above glass pieces, the formation of the above glass gobs, the press-molding of the above glass gobs and the grinding and polishing of the above press-molded products can be carried out according to known methods.

Optical elements including various lenses such as spherical lenses were produced in the above manner. An optical multi-layered film such as an anti-reflection film or the like may be formed on the surface of the above optical element.

### Example 12

In the same manner as in Example 11, glass pieces called “cut pieces” were prepared. They were ground and polished to obtain precision press-molding glass gobs whose entire surface each was smooth, and each gob had a predetermined weight.

A mold release film may be formed on the surface of each of the glass gobs as required. Each glass gob was separately introduced into a precision-press mold, the glass gob and the mold were heated together and the glass gob was precision press-molded to form an optical element. In this manner, optical elements formed of the glasses of Examples 1 to 10 were obtained.

In the above method, the glass gob and the precision-press mold were heated together, while there may be employed a constitution in which a glass gob separately heated is introduced into a pre-heated precision-press mold and precision press-molded to produce an optical element.

The formation of the glass shaped materials, the production of the glass pieces, the production of the glass gobs and the precision press-molding of the glass gobs can be carried out by known methods.

In the above manner, optical elements including various lenses such as aspherical lenses were produced. An optical multi-layered film such as an anti-reflection film may be formed on the surface of each optical element as required.

### Example 13

In the same manner as in Examples 11 and 12, a refined and homogenized molten glass was prepared. The molten glass was caused to flow out of a pipe made of platinum at a constant flow rate, and molten glass masses having a predetermined weight each were consecutively separated from the forward end portion of the molten glass that flowed from the pipe, and shaped on a shaping mold into a glass mass each when they were cooled.

The glass masses were annealed to reduce their strains, and they were machine-processed to obtain glass gobs.

A powdery mold release agent such as boron nitride, or the like was uniformly applied to the surface of each of the above glass gobs, and each glass gob was heated to be softened and press-molded with a press mold in atmosphere. Each of the press-molded products had a form obtained by adding a margin to be removed by machine-processing to the form of an optical element as an end product. The press-molded products were annealed to reduce their strains, and then they were ground and polished to give optical elements formed of the glasses of Examples 1 to 10. Defects such as polishing marks, etc., were not observed on the surface of each of the above-produced optical elements, and quality optical elements could be produced. Further, the above machine-processing was carried out without breaking any glass.

In addition, the separation of the molten glass masses, the shaping them into the glass masses, the machine-processing of the glass gobs, the press-molding of the above glass gobs and the grinding and polishing of the above press-molded products can be carried out according to known methods.

Optical elements including various lenses such as spherical lenses were produced in the above manner. An optical multi-layered film such as an anti-reflection film or the like may be formed on the surface of the above optical element.

### Example 14

A glass mass was formed in the same manner as in Example 13, the glass mass was used as a glass gob and precision press-molded. The precision press-molding was carried out in the same manner as in Example 12.

The formation of a glass shaped material, the production of a glass piece, the production of a glass gob and the precision press-molding of the glass gob can be carried out according to known methods.

In the above manner, optical elements including various lenses such as aspherical lenses were produced. An optical multi-layered film such as an anti-reflection film may be formed on the surface of each optical element as required.

### Example 15

Glass materials were heated, melted, refined and homogenized in a melting vessel to obtain a molten glass, and the molten glass was caused to flow into a mold to obtain a glass shaped material having the form of a rod, a glass shaped material having the form of a plate, and the like. In this manner, glass shaped materials formed of the glasses of Examples 1 to 10 were obtained.

These glass shaped materials were gradually cooled and cut or split, and optical elements were completed by grinding or polishing the thus-cut or split pieces. Defects such as polishing marks, etc., were not observed on the surfaces of the thus-produced optical elements, and quality optical elements were obtained. Further, the above glass shaped materials were machine-processed without any breaking.

The formation, cutting or splitting of the glass shaped materials and the grinding and polishing of the cut or split glass pieces can be carried out by known methods.

In the above manner, optical elements including various lenses such as aspherical lenses were produced. An optical multi-layered film such as an anti-reflection film may be formed on the surface of each optical element as required.

### Example 16

Glass raw materials were heated, melted, refined and homogenized in a melting vessel to obtain a molten glass, the molten glass was caused to flow out at a constant rate, the molten glass flow was cut with a cutting blade called a “shear” to separate a molten glass mass from the molten glass flow, and the molten glass mass was press-molded in a press mold.

Press-molded products formed of the glasses of Examples 1 to 10, obtained in the above manner, were annealed to reduce their strains, ground and polished to give optical elements.

The separation from the molten glass flow, the press-molding of the molten glass mass, the grinding and polishing of the press-molded product, and the like can be carried out according to known methods.

In the above manner, optical elements including various lenses such as aspherical lenses were produced. An optical multi-layered film such as an anti-reflection film may be formed on the surface of each optical'element as required.

### INDUSTRIAL UTILITY

The optical glass of the present invention has high-refractivity, low-dispersion and anomalous partial dispersion properties and has excellent processability, and it can be suitably used, for example, as a glass for a lens that is used in a camera, a projector or the like.

1. An optical glass comprising P⁵⁺, Al³⁺ and alkaline earth metal ions selected from the group consisting of Mg²⁺, Ca²⁺, Sr²⁺ and Ba²⁺ as essential cationic components and comprising F⁻ and O²⁻ as essential anionic components,
wherein the ratio of content of Ba²⁺ to the total content R²⁺ of Mg²⁺, Ca²⁺, Sr²⁺ and Ba²⁺, Ba²⁺/R²⁺, is 0.01 or more but less than 0.5 on the basis of cationic %,
the optical glass having an Abbe's number (νd) of 68 or more.

2. The optical glass of claim 1, which contains, by cationic %, 20 to 50% of P⁵⁺ and 0.1 to 20% of Al³⁺.

3. The optical glass of claim 1, wherein the total content of Mg²⁺, Ca²⁺, Sr²⁺ and Ba²⁺ is 35 to 60 cationic %.

4. The optical glass of claim 1, which contains, by cationic %, 0.1 to 20% of Mg²⁺, 0 to 20% of Ca²⁺, 0 to 20% of Sr²⁺ and 0.1 to 20% of Ba²⁺.

5. The optical glass of claim 1, which contains 0.1 to 10 cationic % of Y³⁺.

6. The optical glass of claim 1, which contains 0.1 to 20 cationic % of B³⁺.

7. The optical glass of claim 1, which contains 30 to 60 anionic % of F⁻.

8. The optical glass of claim 1, which has a refractive index (nd) of 1.54 or more.

9. The optical glass of claim 1, which has a frictional abrasion of 500 or less.

10. The optical glass of claim 1, which has a partial dispersion ratio of 0.535 or more.

11. An optical glass having an Abbe's number (νd) of 68 or more, a partial dispersion ratio of 0.535 or more and a frictional abrasion of 500 or less.

12. The optical glass of claim 11, which contains 0.1 to 20 cationic % of B³⁺.

13. The optical glass of claim 11, which has a refractive index (nd) of 1.54 or more.

14. An optical glass which is to be polished in a polishing step for producing an optical element and which is a fluorophosphate glass having a frictional abrasion of 500 or less.

15. The optical glass of claim 14, which contains 0.1 to 20 cationic % of B³⁺.

16. The optical glass of claim 1, which has a specific gravity of less than 4.0.

17. An optical element formed of the optical glass of claim 1.

18. A process for the production of an optical element, which comprises the steps of preparing a press-molding glass gob formed of the optical glass recited in claim 1, heating said glass gob and press-molding said glass gob.

19. A process for the production of an optical element, which comprises melting a glass, causing the molten glass to flow out to form a glass shaped material formed of the optical glass recited in claim 1 and processing said glass shaped material.
